(19) United States
(12) Patent Application Publication
(10) Pub. No.: US 2026/0024197 A1
(43) Pub. Date: Jan. 22, 2026

(54) DIAGNOSIS OF DEMENTIA

(71) Applicant: Claude Michel Wischik

(72) Inventor: Claude Michel Wischik

(21) Appl. No.: 18/876,983

(22) PCT Filed: Jun. 6, 2023
(86) PCT No.: PCT/EP2023/065075

§ 371 Date: Dec. 19, 2024

(51) Int. Cl. G06T 7/00; G06N 3/0464; G06N 3/08

(52) U.S. Cl. CPC G06T 7/0012; G06N 3/0464; G06N 3/08; G06T 2207/10104; G06T 2207/20081; G06T 2207/30016

(57) ABSTRACT

Diagnosis of dementia A method for diagnosing dementia subtypes is described. The method comprises obtaining brain imaging data relating to one or more patients, analysing the data using a deep learning model and classifying the one or more patients between a plurality of classes comprising a first class of patients having a first subtype of dementia and a second class of patients having a second subtype of dementia, using the deep learning model. The deep learning model has been trained using brain imaging data from patients, the brain imaging data comprising a first set of images showing evidence of temporo-parietal hypo-metabolism, and a second set of images showing evidence of hypo-metabolism in regions of the brain other than the temporal and preictal regions instead or in addition to the temporal and parietal regions, wherein the first set of images is labeled as associated with the first sub-type of dementia and the second set of images is labeled as associated with the second subtype of dementia. Related systems and methods are also described.

### FIELD OF THE INVENTION

The present invention relates to a method for diagnosing subtypes of dementia and particularly, although not exclusively, to a method for classifying patients as having Alzheimer's disease (AD) or mixed dementia such as AD and cerebrovascular disease (CVD, mixed dementia) by analysing brain images, particularly (¹⁸F)-Fluoro-Deoxy-Glucose-Positron Emission Tomography (FDG-PET) images.

### BACKGROUND

Alzheimer's disease (AD) can coexist with other brain pathologies, which also cause cognitive decline, and complicate both the diagnosis and treatment of AD. AD is frequently associated with cerebrovascular disease (CVD) and the presence of both pathologies has an additive impact on cognitive decline. CVD is associated with reduced cognitive performance and reduces the threshold for the clinical presentation of dementia in people with AD. The overlap between the two pathologies has led to the term “mixed dementia”.

Coexistence and heterogeneity of pathologies in people with dementia has led to difficulty in distinguishing typical AD from mixed pathology. FDG-PET has been reported to be superior to other neuroimaging techniques such as magnetic resonance imaging (MRI), computed tomography (CT) and blood flow single photon emission computed tomography (SPECT) in distinguishing other pathologies from AD. However, visual interpretation of FDG-PET images requires intensive training of expert staff and it is time consuming. Further, visual interpretation of FDG-PET images in AD is subjective and dependent on expertise (Morbelli et al., J Alzheimers Dis. 2015; 44(3): 815-26) with the concordance of expert visual analysis with clinical diagnosis being around 90% (Tripathi et al., Neuroradiol J 2014; 27(1): 13-21).

Additionally, visual interpretation of FDG-PET images can miss subtle hypo-metabolism (Jo et al., Front. Aging Neurosci. 2019; 11). This can be detected by semi-quantitative image analysis, using scores or statistics computed over voxel values in the images. The sensitivity and specificity of semi-quantitative analysis has been reported as high as 93% in differentiating probable AD from age matched controls (Herholz et al., Neuroimage. 2002 September; 17(1): 302-16). However, it is not without limitations as semi-quantitative analysis can be prone to inaccurate results especially when assessing the regions in the brain which are either very small or adjacent to each other (Sarikaya et al., J Nucl Med Tech December 2018, 46 (4) 362-367).

Thus, there is a need for improved methods for diagnosing AD, and in particular for distinguishing AD from mixed dementia, that does not suffer from the drawbacks of the prior art.

### SUMMARY OF THE INVENTION

In a first aspect, there is provided a method for diagnosing dementia subtypes in one or more patients, the method comprising: obtaining brain imaging data relating to the one or more patients; and classifying the one or more patients between a plurality of classes comprising a first class of patients having the first subtype of dementia and a second class of patients having the second subtype of dementia, by providing the brain imaging data relating to the one or more patients as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia.

The present inventors have found that metabolic brain imaging data from patients with AD and mixed AD and CVD surprisingly displays significant differences in a number of brain regions that can be quantified semi-quantitatively and used to classify patients between these two subtypes using deep learning image classification models, despite coexistence and heterogeneity of pathologies in people with dementia making it notoriously difficult to distinguish typical AD from mixed pathology using existing methods.

Also described herein is a method of analysing brain imaging data from a patient, the method comprising: obtaining brain imaging data relating to the patient; analysing the data using a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and classifying the one or more patients between a plurality of classes comprising a first class of patients having the first subtype of dementia and a second class of patients having the second subtype of dementia, using the deep learning model.

Obtaining brain imaging data relating to the one or more patients may comprise a processor receiving brain imaging data relating to the one or more patients. The steps of analysing and classifying may be performed by a processor.

The first and second set of images and their associated labels together form a training data set.

The deep learning model may provide as output an indication of the probability that a patient from which an image has been obtained belongs to the first class and/or the second class.

The methods described herein are computer implemented unless context indicates otherwise. Indeed, image analysis using deep learning models, and the process of training deep learning models is of a complexity, and in particular requires the analysis of large amounts of data through complex mathematics, that places the methods described herein far beyond the capability of mental investigation.

In embodiments, the subtypes of dementia are subtypes of Alzheimer's disease (AD). The first subtype of dementia may be AD. The second subtype of dementia may be AD in combination with cerebrovascular disease or vascular dementia. The second type of dementia may be cerebrovascular disease or vascular dementia. The second subtype of dementia may be mixed AD. The second subtype of dementia may be a dementia that is not AD.

Also described herein are methods and systems for diagnosing AD subtypes in one or more patients, the method comprising: obtaining brain imaging data relating to the one or more patients; and classifying the one or more patients between a plurality of classes comprising a first class of patients having the first subtype of AD and a second class of patients having the second subtype of AD, by providing the brain imaging data relating to the one or more patients as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of AD and the second set of images is labelled as associated with a second subtype of AD.

In embodiments, the classifying is between the first class of patients having the first subtype of dementia and the second class of patients having the second subtype of dementia. Thus, the classification may be a binary classification. For example, the classification may discriminate between patients with AD and patients with another subtype of dementia, such as mixed AD or AD and CVD.

In embodiments, the deep learning model is a deep neural network classifier. In embodiments, the deep learning model comprises a convolutional neural network (CNN). In embodiments, the deep learning model comprises a model that has been pretrained on unrelated image data, In embodiments, the deep learning model comprises a CNN that has been pre-trained using a deep residual learning framework.

Convolutional neural networks have been shown to perform particularly well at image recognition tasks. The deep learning model may comprise a model that has been pretrained for image recognition tasks on large collections of image data such as the ImageNet database are available. These CNNs can be partially re-trained on new data, for example by “freezing” (i.e. not retraining) lower level layers that have been trained to identify lower level features in images (such as e.g. the convolutional layers) or only fine tuning said layers, and training or retraining only higher level layers (such as e.g. the classification layers) to identify higher level features that are specifically useful for the classification problem at hand. This partial re-training means that limited amounts of data can be used to rapidly train a deep CNN since only a subset of the parameters of the CNN need to be determined by training (in the case of freezing) and/or only fine-tuning of already optimised parameters needs to be performed. This may be particularly advantageous when the amount of data available for training for the specific classification task at hand is difficult and/or labour intensive to obtain. Deep residual learning is a learning framework that has been developed for image recognition, to address the problem known as “degradation” (the observation that as the network depth increases, the accuracy saturates then degrades rapidly). The deep learning model may comprise a pre-trained CNN that has been trained using deep residual learning, also known as ResNets. In embodiments, the CNN is ResNet18. ResNet18 is a CNN that has been trained on more than a million images from the ImageNet database, and in its native form (before re-training) can classify images into 1000 object categories including e.g. keyboard, pencil, many animals, etc. The CNN was partially re-trained to perform a different image classification task (a process called “transfer learning”) as described herein.

In embodiments, the deep learning model comprises all layers of a CNN that has been pretrained for image recognition apart from the classification layer, and a classification layer trained using the first and second set of images and associated labels. In embodiments, the classification layer comprises a fully connected layer and a softmax layer.

In embodiments, the images in the first set and the second set show evidence of different metabolic activity in any one or more of, or all of: the right frontal cortex, left frontal cortex, right temporal cortex, left temporal cortex, right parietal cortex, left parietal cortex, left cerebellum and right cerebellum. In embodiments, the images in the second set of images show evidence of hypo-metabolism in regions of the brain comprising one or more of, or all of: the right frontal cortex, left frontal cortex, left cerebellum and right cerebellum, instead or in addition to one or more of: the right temporal cortex, left temporal cortex, right parietal cortex, and left parietal cortex.

In embodiments, hypo-metabolism refers to a lower glucose uptake rate and/or blood flow and/or FDG-PET derived Standardized Uptake Value Ratio (SUVR) than expected for a control. A control may be a standard representative of a healthy patient.

In embodiments, the brain imaging data is imaging data acquired using any functional brain imaging modality providing information about the metabolic activity of a brain region imaged. In embodiments, the information about the metabolic activity of a brain region imaged is obtained by detecting glucose uptake by a brain region imaged and/or blood flow to the brain region imaged.

In embodiments, the brain imaging data is FDG-PET data or ASL data. In embodiments, the brain imaging data is baseline functional brain imaging data.

In embodiments, analysing the data using a deep learning model comprises analysing a single section of the brain imaging data for each patient. In embodiments, the method comprises selecting a single section of a set of brain imaging data for each patient. In embodiments, the single section is a single axial section at the level of the thalamus and/or wherein the single section is a section including at least part of the hippocampus and entorhinal cortex.

In embodiments, the brain imaging data used to train the deep learning model comprises a single section of a set of brain imaging data for each of the plurality of patients. In embodiments, the method comprises selecting a single section of a set of brain imaging data for each of the plurality of patients. In embodiments, the single section is a single axial section at the level of the thalamus. In embodiments, the single section is a section including at least part of the hippocampus and entorhinal cortex. A single section refers to a single image and the two terms may be used interchangeably. The present inventors have identified that it was possible to accurately classify patients as having AD or mixed AD using a single section of a set of brain imaging data. They have further identified that this section should preferably be an axial section at the level of the thalamus.

In embodiments, the method may be repeated for one or more further sections and the classifications from each of the sections analysed may be combined to obtain a classification for a patient. Alternatively, the deep learning model may be configured to take as input a plurality of images and produce as output a classification of the plurality of images. For example, the deep learning model may comprise a plurality of instances of a deep learning models as described herein, each taking as input a single image, and a function combining the output of said models to obtain a classification for the plurality of images.

In embodiments, the first set of images comprises one or more images for each of at least 30, at least 40, at least 50, at most 500, at most 200 or at most 100 patients. In embodiments, the second set of images comprises one or more images for each of at least 30, at least 40, at least 50, at most 500, at most 200 or at most 100 patients. In embodiments, the first set of images comprises one or more images for each of a number of patients that is within 10% or within 20% or the number of patients for which one or more images are included in the second set of images. In embodiments, the first and second sets of images comprise one or more images for each of a plurality of patients wherein the plurality of patients for the first and second sets of images are age- and sex-matched.

The present inventors have surprisingly discovered that it was possible to train a deep learning network to accurately distinguish subtypes of dementia using relatively small amounts of training data that has the characteristics described herein (i.e. specific patterns of hypometabolism).

Age and sex-matched groups of patients may refer to groups of patients that have about the same average and/or distribution of ages and sexes. For example, the groups of patients may have average ages within 10% of each other, and/or proportions of female and male patients within 10% of each other, and/or proportions of patients in one or more age categories within 10% of each other.

In embodiments, the first set of images has been labelled as associated with a first subtype of dementia and the second set of images has been labelled as associated with a second subtype of dementia by expert reviewing of the first and second set of images, optionally wherein each image of the first set of images and the second set of images has been assigned the same label by at least two experts. Thus, images in the first set of images may be assigned a label associated with a first subtype of dementia if at least two independently obtained expert-derived labels are the same. Similarly, images in the second set of images may be assigned a label associated with a second subtype of dementia if at least two independently obtained expert-derived labels are the same. Images that have not been assigned the same label by at least two experts may be excluded from the first and second set of images.

In embodiments, the brain imaging data used to train the deep learning model comprises images from a plurality of patients and images obtained from images from the images form the plurality of patients by image augmentation. In embodiments, the image augmentation comprises creating a flipped version of one or more of the images and/or creating a randomly rotated version of one or more of the images. For example, a set of images (e.g. one or more, or all of the original images) may be rotated by a randomly selected amount between predetermined boundaries, such as e.g. −30 to +30 degrees. As another example, a set of images (e.g. one or more, or all of the original images) may be horizontally flipped.

In embodiments, the deep learning model classifies images in the first and second classes with an accuracy of at least 90%, or at least 95%. In embodiments, the deep learning model classifies images in the first and second classes with a sensitivity of at least 90%, or at least 94%. In embodiments, the deep learning model classifies images in the first and second classes with a specificity of at least 90%, or at least 95%. The accuracy, specificity and/or sensitivity of the deep learning model classification can be measured by performing cross-validation, such as e.g. 5 or 10-fold cross validation, and quantifying the accuracy, specificity and/or sensitivity for each split of the cross-validation, and optionally as an average or other summary metrics over the plurality of splits.

In embodiments, the method further comprises training the deep learning model using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia.

According to a second aspect, there is provided a method of providing a tool for diagnosing dementia subtypes in one or more patients, the method comprising: obtaining training image data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and training a deep learning model to classify a patient between a plurality of classes comprising a first class of patients having the first subtype of dementia and a second class of patients having the second subtype of dementia, using the training image data.

The method of the present aspect may have any of the features described in relation to the first aspect. The method of the present aspect is preferably computer implemented. As explained above, at least the step of training a deep learning model are computer implemented in any practical application. Therefore, the steps of the method may comprise a processor executing instructions to perform the said step. For example, obtaining training image data may comprise a processor executing instructions to obtain training image data from a data source (e.g. a database, computer memory, etc.). Similarly, training a deep learning model may comprise a processor executing instructions to train a deep learning model.

Training the deep learning model may comprise at least partially retraining a pretrained deep learning model. Partially retraining the deep learning model may comprise fixing the parameters of one or more of the lower layers of the model, and determining the parameters of the remaining (higher level) layers of the model. Partially retraining the deep learning model may comprise fine tuning the weights of a plurality of layers of the deep learning model and training the weights of one or more further layers. The one or more further layers may be a classification layer. The classification layer may comprise a fully connected layer and a softmax layer.

According to any aspect described herein, obtaining brain imaging data may comprise receiving the brain imaging data from a computing device, imaging data acquisition means, data store or user interface. The method of any aspect may comprise obtaining brain imaging data from a patient. In some cases, the methods comprise administering an imaging tracer to a patient and obtaining brain imaging data from said patient. This step may not be computer implemented and may precede any computer implemented step performed on the data acquired. Alternatively, all of the steps of the method may be computer-implemented and comprise receiving previously acquired brain imaging data.

The methods of any aspect may comprise providing to a user, for example through a user interface, the results of the classification, the trained deep learning model, and/or any information derived therefrom. A data store may be a public or private database. The results of the classification may comprise one or more of: a probability of belonging to the first and/or second class obtained using the deep learning model, a classification label for one or more images, a classification label for one or more patients, a trained deep learning model, the values of parameters (e.g. architecture and weights) of a trained deep learning model. Information derived from the results of the classification may comprise one or more of: a prognostic indication derived from a classification obtained using the deep learning model, a therapeutic indication derived from a classification obtained using the deep learning model, an indication of suitability for taking part in a clinical trial derived from a classification obtained using the deep learning models, etc.

According to a third aspect, there is provided a method of selecting a subject that has been diagnosed as having AD or being likely to have AD for participation in a clinical trial, the method comprising: classifying the subject between a plurality of classes comprising a first class of patients having the first subtype of dementia and a second class of patients having the second subtype of dementia, by providing brain imaging data relating to the subject as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and selecting or excluding the subject from participation in the clinical trial depending on whether the subject was classified as having a first dementia subtype or a second dementia subtype.

The methods of the present aspect may have any of the features described in relation to the first aspect. In particular, the method may comprise selecting the subject for participating in the clinical trial if the subject is classified in the first class. The method may comprise excluding the subject from participating in the clinical trial if the subject is classified in the second class. The clinical trial may be a trial for treating AD. The method of the present aspect may include any combination of some, all or none of the above described preferred and optional features.

According to a fourth aspect, there is provided a method of providing a prognosis for a subject that has been diagnosed as having AD of being likely to have AD, the method comprising: classifying the subject between a plurality of classes comprising a first class of patients having the first subtype of dementia and a second class of patients having the second subtype of dementia, by providing brain imaging data relating to the subject as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and determining a prognosis for the subject based on whether the subject was classified as having a first dementia subtype or a second dementia subtype, optionally wherein determining a prognosis comprises determining that the subject is likely to have a faster rate of cognitive decline if the subject is classified in the second class than if the subject is classified in the first class. The method of the present aspect may include any combination of some, all or none of the above described preferred and optional features.

According to a fifth aspect, there is provided a system for diagnosing dementia subtypes and/or providing a tool for diagnosing dementia subtypes, the system comprising: one or more processors and computer readable memory storing instructions that cause the processor to perform the method of any embodiment of any preceding aspect, including in particular any embodiment of the first and/or second aspect. The system may further comprise data acquisition means configured to obtain brain imaging data relating to one or more patients. In some embodiments, the system may comprise one or more computers, servers, or cloud-based devices, for example.

According to a sixth aspect, there is provided a non-transitory computer readable storage medium containing machine executable instructions which, when executed on a processor, cause the processor to perform the method of any embodiment of the first to fourth aspect, including any one, or any combination insofar as they are compatible, of the optional features set out with reference thereto.

According to a seventh aspect, there is provided a computer program comprising executable code which, when run on a computer, causes the computer to perform the method of any embodiment of any preceding aspect, including in particular any embodiment of the first to fourth aspect, including any one, or any combination insofar as they are compatible, of the optional features set out with reference thereto.

The invention includes the combination of the aspects and preferred features described except where such a combination is clearly impermissible or expressly avoided.

### SUMMARY OF THE FIGURES

Embodiments and experiments illustrating the principles of the invention will now be discussed with reference to the accompanying figures in which:

FIG. 1 shows examples of FDG-PET images showing evidence of temporo-parietal hypo-metabolism, also referred to herein as “typical AD pattern” of hypo-metabolism (A), and images showing evidence of hypo-metabolism in regions of the brain other than the temporal and parietal regions (B), also referred to herein as “mixed pattern” of hypo-metabolism, in particular, patchy hypo-metabolism in other vascular territories of brain such as frontal and cerebellar regions along with temporo-parietal hypo-metabolism. A=anterior, P=posterior, L=left, R=right, H=superior, F=inferior.

FIG. 2 shows schematically the architecture of a deep learning model according to embodiments of the methods of the disclosure. The figure shows in particular a modified ResNet-18 architecture used in the examples of the present disclosure.

FIG. 3 shows occlusion sensitivity maps for a deep learning model exemplified in the disclosure, for the classification of a first subtype of patients showing a typical AD hypometabolism pattern (A) or a second subtype of patients showing a mixed pattern of hypometabolism (B).

FIG. 4 is a flow diagram of a method for diagnosing Alzheimer's disease subtypes and/or for providing a tool for diagnosing AD subtypes.

FIG. 5 is a schematic of a system for performing the method of FIG. 4.

### DETAILED DESCRIPTION OF THE INVENTION

Aspects and embodiments of the present invention will now be discussed with reference to the accompanying figures. Further aspects and embodiments will be apparent to those skilled in the art. All documents mentioned in this text are incorporated herein by reference.

The inventors carried out an analysis of brain images (in particular FDG-PET scans) from patients with two different types of AD (AD and mixed AD and CVD) and showed for the first time that these two subtypes can be identified using semi-quantitative image analysis, were different clinically and could be distinguished with very high accuracy using automated image analysis using a deep neural network model trained by transfer learning.

### Method for Diagnosing Dementia Subtypes

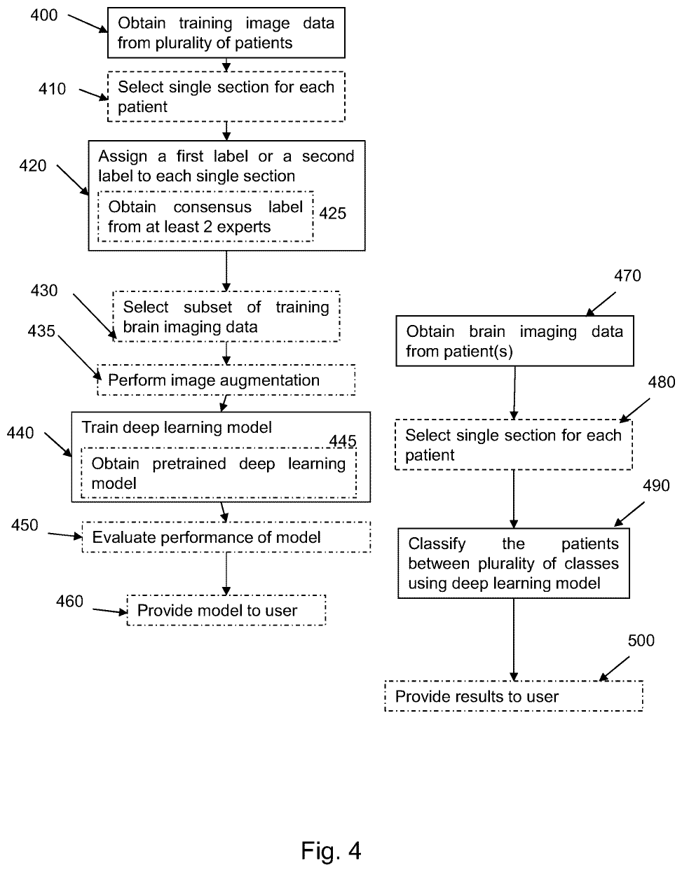

FIG. 4 shows a flow diagram of a method for diagnosing subtypes of dementia in a target patient, and a method of providing a tool for diagnosing subtypes of dementia. The method may be performed at one or more computing devices. At step 400, training brain imaging data is obtained from a plurality of patients. The training brain imaging data may be baseline FDG-PET scan data. At optional step 410, a single section (image) is selected for each of the plurality of patients. At step 420, each of the single section is assigned a first label if it shows evidence of temporo-parietal hypo-metabolism, and a second label if it shows evidence of hypo-metabolism in regions of the brain other than the temporal and parietal regions instead or in addition to the temporal and parietal regions. Step 420 may be performed by expert visual analysis, preferably including obtaining at step 425 a consensus label from at least two different experts. At optional step 430, a subset of the training brain imaging data may be selected, for example to include a similar number of images assigned the first and second labels, and/or to include images assigned the first and second labels that are age- and sex-matched. At optional step 435, the training brain imaging data or subset thereof may be subject to image augmentation, for example by flipping and/or rotating one or more of the images. At step 440, the training brain image data (optionally selected and/or augmented) and labels are used to train a deep learning model. Training the deep learning model may comprise at least partially retraining a pretrained deep learning model. The pretrained deep learning model may have been previously trained to perform an unrelated image recognition task. Thus, step 440 may comprise obtaining a pretrained deep learning model at step 445, for example from a memory, data store, user interface or computing device. At optional step 450, the performance of the deep learning model may be evaluated, for example by determining its accuracy, sensitivity and/or specificity when distinguishing mages assigned with the first label and images assigned with the second label. This may be performed using cross-validation, such as e.g. 5-fold cross validation. Thus, the training image data may be divided between training and validation data sets for each iteration of a training and validation process. At optional step 460, the trained deep learning model may be provided to a user. At step 470, brain imaging data relating to one or more patients is obtained. At optional step 480, a single section (image) is selected for each of the one or more patients. At step 490, a deep learning model such as that obtained through steps 400-460 is used to classify the one or more patients between a plurality of classes comprising a first class of patients having the first subtype of dementia and a second class of patients having the second subtype of dementia. At optional step 500, a result of the classification or information derived therefrom is provided to a user. Information derived from the results of the classification may comprise one or more of a diagnosis, prognosis, treatment, selection for a clinical trial, as will be described further below. A method described herein may comprise any of steps 400 to 460 and/or any of steps 470 to 500. Selecting a single image at step 410 and/or 480 may be performed manually or automatically. For example, a predetermined section of any brain image data set may be selected (e.g. a single axial section comprising a predetermined one or more regions of interest such as e.g. the thalamus and/or the hippocampus and/or entorhinal cortex may be selected).

The words “subject” and “patient” are used interchangeably throughout this disclosure.

### Use of Analysis Results

The results of such an analysis can be used to diagnose a patient as having AD or mixed AD, such as combined AD and cerebrovascular disease (CVD). The results of such an analysis can be used to select patients for participating in a clinical trial. For example, a clinical trial may be designed to exclude patients with mixed AD and/or to only include patients with “typical” (i.e. non-mixed) AD. As another example, a clinical trial may be designed to exclude patients with “typical” AD and/or to only include patients with “mixed AD. Also described herein is a method of selecting a subject that has been diagnosed as having AD or being likely to have AD for participation in a clinical trial, the method comprising: analysing one or more brain images from the patient using a method described herein, and selecting or excluding the subject from participation in the clinical trial depending on whether the patient was classified as having a first dementia (or AD) subtype or a second dementia (or AD) subtype.

The results of such an analysis can be used to predict the level of cognitive impairment of a patient having been diagnosed as having AD or being likely to have AD, where patients classified as having mixed AD and CVD are likely to have more severe cognitive impairment than patients with AD. The results of such an analysis can be used to provide a prognosis for a patient that has been diagnosed as having AD or being likely to have AD. Indeed, patients with mixed AD, where AD coexists with CVD show a faster rate of cognitive decline than patients with AD only (see e.g. Zekry et al., Acta Neuropathol 2002; 103:481-7 and Kapasi et al., Acta Neuropathol 2017; 134:171-86). Thus, the present methods can be used to predict whether a patient is likely to have a rate of cognitive decline that is faster than expected for an AD patient. Further, if a treatment became available which were able to treat vascular pathology, then the method could be used to assist in the selection of patients suitable for treatment. For example, Rogriguez et al. (Brain Res 1588 (2014): 144-149) have reported the methylene blue is able to reduce the extent of hypoxaemic damage in brain tissues resulting from occlusion of the carotid artery which supplies the brain. Thus, also described herein is a method of providing a prognosis for a subject that has been diagnosed as having AD of being likely to have AD, the method comprising: analysing one or more brain images from the patient using a method described herein, and identifying a prognosis for the subject based on whether the patient was classified as having a first dementia subtype or a second dementia subtype. For example, a patient being classified in a class of patients with a second subtype of AD may be associated with poor prognosis compared to a patient classified in a class of patients with a first subtype of AD. Poor prognosis may refer to a faster rate of cognitive decline than expected for an AD patient. The expected rate of cognitive decline for an AD patient may be an average rate of cognitive decline observed over a cohort of AD patients. The cohort of AD patients may be age- and sex matched patients that have been diagnosed as having AD. The cohort of AD patients may be patients that have been diagnosed as having AD in the absence of CVD. The cohort of patients may be patients that have been diagnosed as having AD by analysis of FDG-PET images. The cohort of patients may be patients that have only temporoparietal hypometabolism in FDG-PET images.

The results of such an analysis can be used to treat or identify a treatment for a patient with dementia. For example, a patient diagnosed as having “typical” dementia may be treated differently from a patient diagnosed as having mixed dementia comprising AD and vascular dementia/CVD. For example, a patient with mixed dementia may be treated with compounds to treat high blood pressure, lower cholesterol and/or prevent blood clots instead or in addition to compounds to treat AD. As another example, a patient with mixed dementia may be recommended to follow life-style changes such as a change of diet, activity regime, alcohol consumption or tobacco consumption instead or in addition to treatment for AD. AS explained above, a patient with mixed dementia may be recommended or selected for treatment with a therapy to treat vascular pathology, such as e.g. methylene blue. As another example, a patient with dementia may be treated with compounds to treat AD only after vascular dementia has been excluded and/or AD has been diagnosed. Thus, also described herein is a method of identifying a therapy for a subject that has been diagnosed as having dementia or being likely to have dementia, the method comprising: analysing one or more brain images from the patient using a method described herein, and identifying the subject for treatment with a first therapy or a second therapy depending on whether the patient was classified as having a first dementia (or AD) subtype or a second dementia (or AD) subtype. The first therapy may be a therapy for treating AD. The second therapy may be a therapy for treating vascular dementia. The second therapy may comprise a therapy for treating vascular dementia and a therapy for treating AD. Also described herein is a method of selecting a subject having dementia for treatment with a therapy for vascular dementia, the method comprising analysing one or more brain images from the patient using a method described herein, and selecting the subject for treatment with a therapy for vascular dementia if the patient is classified as having the second dementia subtype. Also described herein is a method of selecting a subject having dementia for treatment with a therapy for AD, the method comprising analysing one or more brain images from the patient using a method described herein, and selecting the subject for treatment with a therapy for AD if the patient is classified as having the first dementia subtype. Also described herein is a method of treating a subject with dementia, the method comprising analysing one or more brain images from the subject using a method described herein, and administering to the subject a therapeutically effective dose of a therapy for treating vascular dementia if the subject has been classified in the second class of patients having a second subtype of dementia and/or administering to the subject a therapeutically effective dose of a therapy for treating AD if the subject has been classified in the first class of patients having a first subtype of dementia.

As used herein “treatment” and “therapy” refer to reducing, alleviating or eliminating one or more symptoms of the disease which is being treated, relative to the symptoms prior to treatment.

### Systems

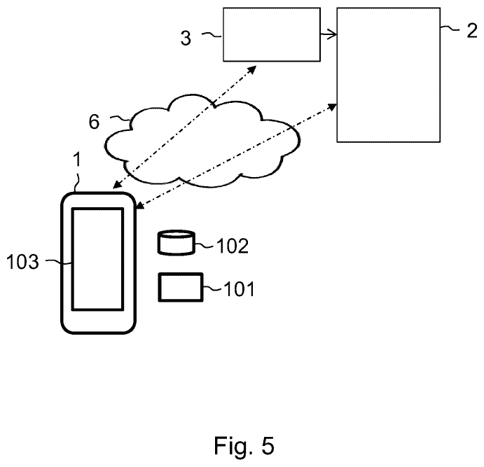

FIG. 5 shows an embodiment of a system for diagnosing AD subtypes and/or classifying a subject as having AD or mixed dementia and/or analysing brain images and/or providing a tool for diagnosing AD subtypes, according to the present disclosure. The system comprises a computing device 1, which comprises a processor 101 and computer readable memory 102. In the embodiment shown, the computing device 1 also comprises a user interface 103, which is illustrated as a screen but may include any other means of conveying information to a user such as e.g. through audible or visual signals. The computing device 1 is communicably connected, such as e.g. through a network, to data acquisition means 3 (also referred to as “brain image data acquisition means”), such as a PET machine or MRI machine or computing device associated therewith, and/or to one or more databases 2 storing brain imaging data. The one or more databases 2 may further store one or more of: one or more deep learning algorithm, training data, parameters (such as e.g. parameters of a deep learning model used to diagnose AD subtypes), clinical and/or sample related information, etc. The computing device may be a smartphone, tablet, personal computer or other computing device. The computing device is configured to implement a method for diagnosing AD subtypes, analysing brain images, and/or classifying a subject as having AD or mixed dementia, as described herein. In alternative embodiments, the computing device 1 is configured to communicate with a remote computing device (not shown), which is itself configured to implement a method as described herein. In such cases, the remote computing device may also be configured to send the result of the method to the computing device. Communication between the computing device 1 and the remote computing device may be through a wired or wireless connection, and may occur over a local or public network 6 such as e.g. over the public internet. The data acquisition means 3 may be in wired connection with the computing device 1, or may be able to communicate through a wireless connection, such as e.g. through WiFi and/or over the public internet, as illustrated. The connection between the computing device 1 and the data acquisition means 3 may be direct or indirect (such as e.g. through a remote computer). The data acquisition means 3 are configured to acquire brain imaging data from a patient. Any imaging protocol that is suitable for use in obtaining information about metabolic activity in the brain of a patient (such as e.g. PET and MRI) may be used within the context of the present invention. The data acquisition means preferably comprises a PET scanner, preferably configured to collect FDG-PET images. The data acquisition means may comprise arterial spin labelling (ASL).

The following is presented by way of example and is not to be construed as a limitation to the scope of the claims.

### Examples

As explained above, using visual interpretation of FDG-PET images together with exploration of findings with semi-quantitative methods may minimise the limitations of traditional methods for detection and monitoring of AD from such images. Recently, automated techniques, such as artificial intelligence (AI) have been proposed as a potential alternative (Jo et al., Front. Aging Neurosci. 2019; 11). Deep learning, a type of machine learning technique, can be trained directly using images, texts, or sound to learn a classification pattern for a given input. The present inventors hypothesised that these techniques could be applied using expert classification of AD subtypes as the gold standard, and classification algorithms could be trained to distinguish between AD and mixed dementia. Deep learning algorithms such as Convolutional Neural Networks (CNN), which take an input image, analyses it according to a trained algorithm and classifies it into certain categories, have been used to analyse medical images (Yadav et al., J Big Data 2019; 6(1): 113). However, training a completely new CNN is challenging and computationally demanding. Validation of models make this method impractical for modest sized datasets having a sample size in hundreds as it requires a large dataset with a sample size in thousands for acceptable accuracy. To address this problem an image classification algorithm can be trained using a large generic image dataset and then subsequently ‘fine-tuned’ using appropriate medical image data. This approach is called transfer learning and is a refinement to CNN that can be applied to smaller datasets.

Introducing advanced methods to classify AD into subtypes will improve diagnostic reliability and has the potential to aid clinical decision making in the management of people with AD. Here, the inventors used visual classification of FDG-PET images to group participants with AD into those with a typical AD pattern of FDG-PET hypo-metabolism (termed “typical”) and those with a mix of a typical AD pattern of FDG-PET hypo-metabolism plus a FDG-PET hypo-metabolism typical of CVD (termed “mixed”). They then assessed differences in these groups by region-of-interest based analysis of SUVR (Standardized Uptake Value Ratio). Further, they built a classification model based on transfer learning of the Residual Network-18 (ResNet-18) architecture (He et al. 2016 IEEE Conference on Computer Vision and Pattern Recognition (CVPR); 2016:770-778) to classify images, considering visual classification as the gold standard. Using data from two large clinical trials of well-characterised people who met the clinical criteria for AD, the inventors aimed to classify people as having typical or mixed AD, using conventional visual classification, and then comparing these with classifications using transfer learning of a convolutional neural network.

### Methods

Selection of participants and recruitment. The present example uses baseline FDG-PET data collected as part of two large scale Phase III clinical trials of a novel tau aggregation inhibitor drug, Leuco-Methylthioninium (LMTX®) in 1690 participants who met research criteria for mild to moderate AD and were aged less than 90 years. 794 participants were included in the current study, with 896 participants excluded due to either lack of FDG-PET imaging data or where their images were incomplete. Details of clinical trial approval and methods have been described in previous publications (see Gauthier et al. The Lancet. 2016; 388(10062): 2873-2884; Wilcock et al., J Alzheimers Dis. 2018; 61(1): 435-457; Schelter et al., J Alzheimers Dis. 2019; 72(3): 931-946). Written informed consent was obtained from every participant before enrolment in the Studies TRx-237-015 (clintrials.gov NCT01689246) and TRx-237-005 (clintrials.gov NCT01689233). Consent for the patients lacking decision-making capacity was provided by legal representatives.

FDG PET Imaging Protocol. Brain images were obtained with positron emission tomography computerized tomography (PET CT) using high-resolution PET devices, such as the Siemens High Resolution Research Tomograph (HRRT) system or GE medical systems Discovery STE, that use a transmission source or low dose CT for attenuation correction. The PET sites had to undergo stringent quality criteria set and checked by Molecular NeuroImaging (mnimaging.com) before participant recruitment. A standard dose of 5 mCi/185 MBq (+10%) FDG was injected intravenously over a period of 1 minute in antecubital region through an indwelling catheter. PET images were acquired 30 minutes (+5 minutes) after administration of FDG.

Image reconstruction and processing. Images were reconstructed with an image matrix of 128×128 with a slice thickness of 4 mm. The images were zoomed at Field of View (FOV) of 350 mm with Gaussian Full Width at Half Maximum (FWHM) smoothing of 5.0 mm. A standard low dose non-diagnostic CT acquisition of the head was acquired for attenuation correction. The images were assessed for artefacts, patient motion, excessive noise, low counts and patient positioning.

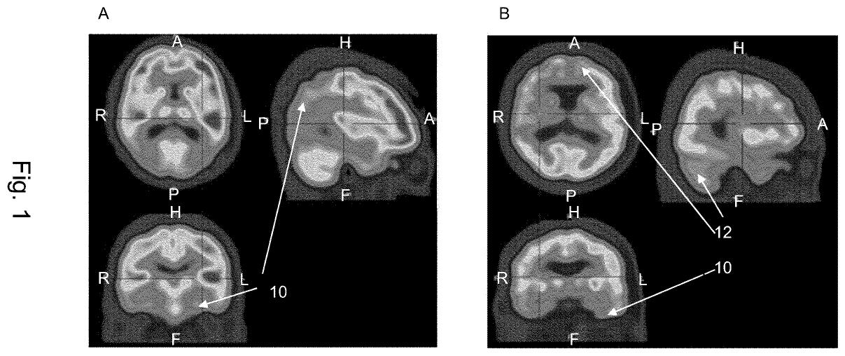

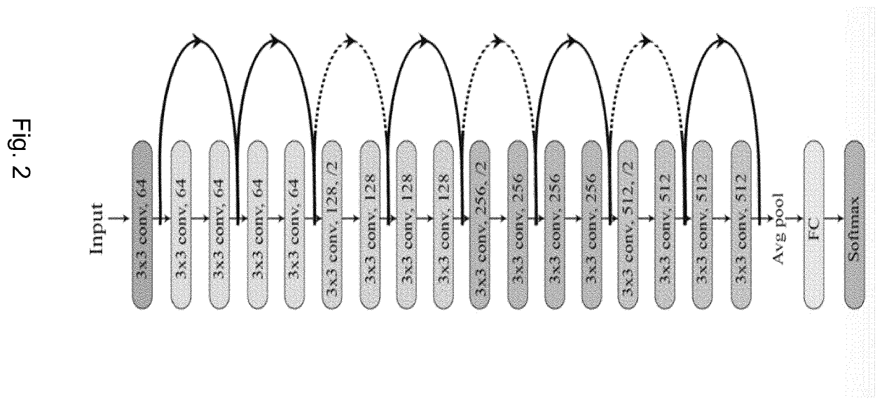

Visual classification of FDG-PET images. FDG-PET images were classified using visual inspection into those with a typical AD pattern with temporo-parietal hypo-metabolism (see e.g. Marcus et al. Clin Nucl Med 2014; 39:e413-26; Milke et al., Eur J Nucl Med 1994; 21:1052-60; Kerrouche et al., J Cereb Blood Flow Metab 2006; 26:1213-21; Garibotto et al., Neurobiol Aging 2017; 52:183-95) and those with a pattern of mixed AD and CVD (mixed pattern), with temporo-parietal hypometabolism and deficits in one or more vascular territories (i.e. known blood supply regions of the brain such as the middle cerebral artery). Scans with a typical AD FDG-PET profile had decreased glucose uptake restricted to temporoparietal regions (see FIG. 1A). Those with a mixed AD/CVD profile had reduced FDG uptake in a particular vascular territory, such as the middle cerebral artery and/or patchy uptake, in addition to typical temporoparietal hypometabolism (see FIG. 1B). PMOD Alzheimer's discrimination analysis tool (PALZ, Haense et al., Journal of Nuclear Medicine. 2008; 49(supplement 1): 34P-34P) was used for visualisation of the FDG-PET images. The classification was based on a visual review of scan images displayed in three planes using a standard colour scale representing FDG uptake. In order to determine the level of inter-rater variability a subset of the data was classified by a second trained observer and Cohen's Kappa calculated. There was a moderate level of agreement between raters. The inter-rater reliability, measured using Cohen's kappa, was 0.55 indicating an acceptable level of agreement. In cases of disagreement, images were reviewed jointly and discussed until a consensus was reached. The final consensus classification obtained by the two raters was used as gold standard for the purpose of training the machine learning model (see below). FIG. 1 shows an example of FDG pet images of the brain of a participant classified with A), typical AD pattern of glucose metabolism with temporo-parietal hypo-metabolism regions 10 and B) mixed pattern with patchy hypo-metabolism in other vascular territories of brain such as frontal and cerebellar regions 12 along with temporo-parietal hypo-metabolism regions 10.

Analysis of visually classified FDG-PET images. Quantification of FDG-PET metabolism was achieved by determining the Standardized Uptake Value Ratio (SUVR) of different brain regions, namely right and left frontal cortices, right and left temporal cortices, right and left parietal cortices, right and left occipital cortices and right and left cerebellar cortices with intensities normalised to the pons (Nugent et al., Scientific Reports. 2020; 10(1):9261).

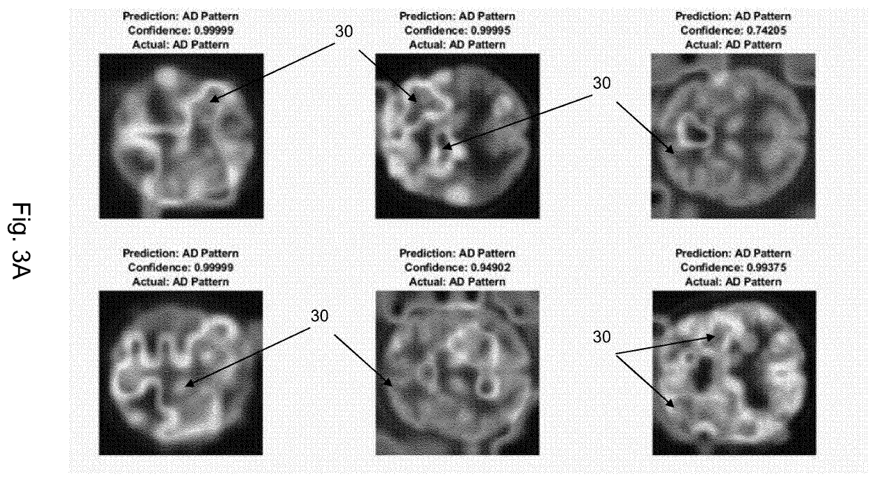

Description of Transfer Learning method. For the purpose of transfer learning, 50 age- and sex-matched participants were selected using covariate-adaptive randomisation each from visually classified AD and mixed groups. Note that it is not necessary for the learning data set to comprise equal numbers of participants in both groups, or age and sex matched participants. However, the use of age and sex matched participants may increase the reliability of the resulting classifier, in terms of how well it performs in validation tests (i.e. how its performance generalises to other datasets than that with which it was trained). FDG-PET images of the participants were normalised to a PET template (PET template included in SPM12) in standard Montreal Neurological Institute (MNI) space using SPM12 (available at www.fil.ion.ucl.ac.uk/spm/software/spm12), implemented in MATLAB R2020a. A single axial section at the level of the thalamus was used as the input for transfer learning of ResNet-18. Note that any image, and in particular any axial section, including the areas around the hippocampus and entorhinal cortex may be used. Image augmentation was performed by creating a flipped version (horizontal flipping) of each axial section and then randomly rotating the sections by −30 to 30 degrees. Image augmentation advantageously reduces the risk of overfitting the network to the training images. Twenty data sets (i.e. single images from 20 patients) were reserved for testing while the remaining 80 were split into training and validation datasets in an 80%/20% ratio. The final classification layer of ResNet-18 was replaced with a new fully connected layer comprising 2 classes to represent the mixed and AD groups. ResNEt-18 is an18 layers deep convolutional neural network (CNN). The version used was pretrained on more than one million images from the ImageNet database (www.image-net.org), and implemented in MatLab. FIG. 2 shows the stages of dataflow of the machine learning algorithm used in this study. In particular, FIG. 2 shows the basic architecture of ResNet-18 showing different layers of CNN. The figure shows skip connections (skip some layers in neural network and feeds the output of one layer as input to the next layer) in the form of dotted lines and numbers depicting output size. Avg pool is a global average pooling layer which reduces the spatial size of the representations, computational complexity and number of parameters and the FC is a 1000-way fully connected layer, which is a feed forward neural network with 1000FC sub-layers and full connection to all previous sublayers. The last layer is a softmax layer which is the last activation function of the neural network and is used to normalise the output of the network to provide an output between 0 and 1. Five-fold cross validation was employed and mean accuracy of the five folds is reported. The network was trained using the trainNetwork functionality in MatLab, whereby the weights of the pre-trained network are fine-tuned using the training images, rather than using randomly initialised weights to train a network “from scratch”. This advantageously resulted in a fast training and very good performance despite the relatively modest size of the training data set available.

Statistical Analysis. All statistical analyses were performed with SPSS Version-26. Descriptive statistics are presented, with comparison of means where appropriate. Student's t test was used to test for differences in means for normally distributed continuous data and chi square test used to find the differences in binary data. Relationships between variables were further explored with general linear modelling, where appropriate. P values of <0.05 were considered significant and the convention of indicating levels of significance were *<0.05, **<0.01, ***<0.001. Further, the sensitivity, specificity and accuracy between true and predicted subtypes of AD were calculated.

### Results

Table 1 shows the demographic and clinical characteristics of the participants in this study. The average age of the participants was 70.56 years with more females (55.16% vs 44.83%) participating. From the total of 794 (438 female) participants, 533 (284 female) were classified as typical AD and 261 (154 female) participants classified as mixed (Table 1). Further, 100 age- and sex-matched participants (50 each from typical AD and mixed) were selected for the purpose of transfer learning. The participants classified as having mixed hypo-metabolism were younger in age and more cognitively impaired in comparison with typical AD participants.

TABLE 1
Comparison of demographic and clinical characteristics with visual FDG-PET AD classification.

| Parameters | All | Typical AD | Mixed | P value |
|---|---|---|---|---|
| n | 794 | 533(67.2%) | 261(32.8%) | 0.042 (One |
| | | | | sample |
| | | | | binomial |
| | | | | test for |
| | | | | proportions) |
| Mean Age (SE) | 70.56 (9.02) | 71.23 (0.392) | 69.17 (0.545) | 0.002(t test) |
| ADAS Cog | 19.15 (8.43) | 17.89 (0.340) | 21.69 (0.556) | <0.001(t test) |
| score (SE) | | | | |
| Sex | 356 (44.83%)-Male | 249 (46.72%)-Male | 107 (40.99%)-Male | 0.148(Chi |
| | 438 (55.17%)- Female | 284 (53.28%)-Female | 154 (59.01%)-Female | square test) |

Table 2 shows mean SUVR differences in various Regions of Interests (ROIs) with respect to those with typical AD and mixed subtypes. The ROIs used were standing regions in Montreal Neurological Institute (MNI) standard space, created in standard space and copied to the normalized version of the patient data. Significant differences were found comparing mean SUVR of AD and mixed pattern subtypes in right and left frontal, right temporal, right and left parietal cortices. However, no significant differences were found in left temporal cortex, right and left occipital cortices and right and left cerebellum.

TABLE 2
Comparison of regional SUVR in typical AD and mixed.

| Regions of | AD | | Mean | Std. Error | |
|---|---|---|---|---|---|
| Interest | Subtype | Number(N) | SUVR | of Mean | P-Value |
| Left Frontal | Mixed | 248 | 1.32 | 0.011 | <0.001** |
| Cortex | Typical AD | 518 | 1.36 | 0.005 | |
| Right Frontal | Mixed | 248 | 1.31 | 0.011 | <0.001** |
| Cortex | Typical AD | 518 | 1.36 | 0.005 | |
| Left Temporal | Mixed | 248 | 1.15 | 0.007 | ns |
| Cortex | Typical AD | 518 | 1.17 | 0.005 | |
| Right Temporal | Mixed | 248 | 1.16 | 0.008 | <0.001** |
| Cortex | Typical AD | 518 | 1.19 | 0.005 | |
| Left Parietal | Mixed | 248 | 1.29 | 0.012 | 0.003 * |
| Cortex | Typical AD | 518 | 1.33 | 0.007 | |
| Right Parietal | Mixed | 248 | 1.29 | 0.012 | <0.001** |
| Cortex | Typical AD | 518 | 1.34 | 0.007 | |
| Left Occipital | Mixed | 248 | 1.42 | 0.011 | ns |
| Cortex | Typical AD | 518 | 1.41 | 0.007 | |
| Right Occipital | Mixed | 248 | 1.44 | 0.011 | ns |
| Cortex | Typical AD | 518 | 1.43 | 0.007 | |
| Left Cerebellar | Mixed | 248 | 1.27 | 0.007 | ns |
| Cortex | Typical AD | 518 | 1.29 | 0.004 | |
| Right Cerebellar | Mixed | 248 | 1.25 | 0.007 | ns |
| Cortex | Typical AD | 518 | 1.27 | 0.004 | |

Significance levels adjusted for Bonferroni correction and considered significant if * P < 0.005, **P < 0.001 and ns—not significant.

Further, AD subtypes were compared with different Regions of Interests (ROIs), controlling population weighted age and sex by using these in the contrasts of the statistical analysis (Table 3) and it was observed that SUVR was lower in those with a mixed pattern in all ROIs except right and left occipital cortices. The SUVR in right frontal cortex was statistically significant when correlated with dementia subtypes.

TABLE 3
Comparison of regional uptake in Typical AD
and mixed subtypes, controlling Age and Sex.

| | Age | Sex | AD subtypes |
|---|---|---|---|
| Left Frontal | −0.001 | 0.015 | −0.030 |
| Effect (P value) | (.039*) | (.247) | (.085) |
| Right Frontal | −0.001 | 0.005 | −0.040 |
| Effect (P value) | (0.236) | (0.662) | (0.023*) |
| Left Temporal | −0.001 | 0.016 | −0.009 |
| Effect (P value) | (<0.001***) | (0.115) | (0.509) |
| Right Temporal | −0.001 | 0.008 | −0.022 |
| Effect (P value) | (0.034*) | (0.450) | (0.138) |
| Left Parietal | 0.001 | 0.026 | −0.018 |
| Effect (P value) | (0.028*) | (0.077) | (0.36) |
| Right Parietal | 0.002 | 0.018 | −0.031 |
| Effect (P value) | (0.001***) | (0.239) | (0.141) |
| Left Occipital | 0.001 | 0.013 | 0.036 |
| Effect (P value) | (0.253) | (0.386) | (0.080) |
| Right Occipital | 0.001 | 0.008 | 0.026 |
| Effect (P value) | (0.464) | (0.569) | (0.216) |
| Left Cerebellum | 0.0001 | 0.017 | −0.013 |
| Effect (P value) | (0.752) | (0.061) | (0.299) |
| Right Cerebellum | 0.001 | 0.009 | −0.011 |
| Effect (P value) | (0.305) | (0.334) | (0.396) |

Effect = beta, Age = Population weighted Age, AD subtypes = AD pattern and mixed pattern, considered significant if P < 0.05.

A ResNet-18 based classification model trained with transfer learning was found to have a sensitivity, specificity and accuracy of 94.73%, 95.23% and 95% respectively for one randomly selected cross-validation loops. The average accuracy after 5-fold cross validation was found to be 97.5%.

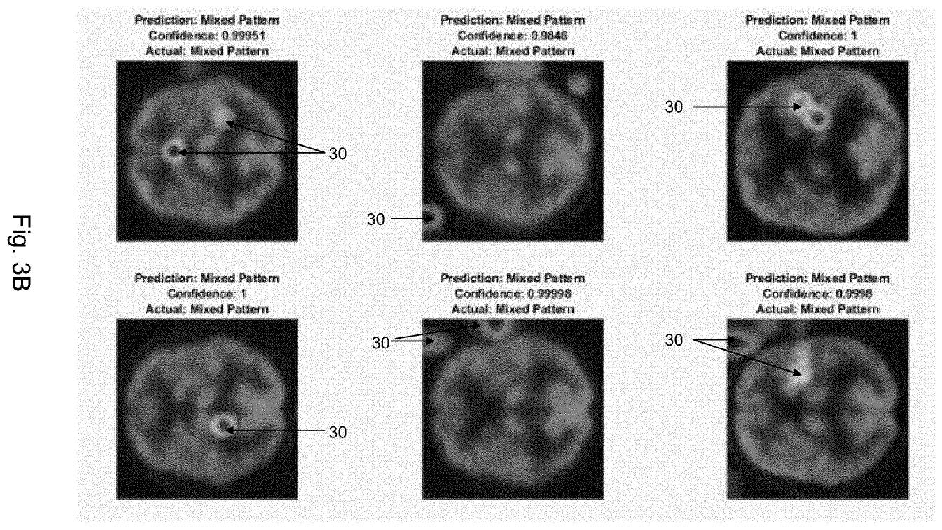

FIGS. 3A and 3B show occlusion sensitivity maps of six participants each from the typical AD (A) and mixed pattern (B) groups respectively. The occlusion maps show which regions 30 of the image have a positive contribution towards group classification. Occlusion measures the network's sensitivity (drop in probability score for a particular class) to occlusion in different regions of the images by replacing small areas in the images with an occluding mask (e.g. a grey square). FIGS. 3A and 3B show that the most informative regions to classify patients between AD and mixed pattern are those highlighted in FIG. 3A, i.e. those that are strong indicators of the AD pattern of hypometabolism.

### Discussion

This study is first of its kind to not only to sub-classify people with AD based on their FDG-PET images but also introduce an automated classification approach using FDG-PET images analysed using a machine learning algorithm trained using data from traditional visual analysis, in particular using an advanced technique of transfer learning for classification using FDG-PET images. The inventors visually classified people with AD into typical AD and mixed subtypes based on the hypometabolic patterns seen in their FDG-PET images and considered this classification as the gold standard. The two subtypes of Alzheimer's disease based on visual analysis of FDG-PET were not only significantly differed in terms of visually determined patterns of glucose uptake but also differed in clinical and demographic characteristics in that people with mixed subtype were younger in age and were more cognitively impaired. To explore the findings of visual analysis a semi-quantitative analysis was done and SUVR was calculated in standard ROIs. The areas corresponding to metabolic defects on visual analysis had lower SUVR. Notably, in the current study the glucose uptake was higher in those with typical AD in comparison to mixed in most of the ROIs except the occipital cortex where no significant difference was found. Uptake was lower in those with a mixed classification in comparison to those with typical AD, suggesting poorer blood supply in most regions in those with a mixed pattern and in keeping with widespread reduced metabolism of brain parenchyma. This is in line with recent studies, suggesting people with both AD and cerebrovascular lesions have more severe disease than people with AD alone (De Reuck J. Neurol Res Int. 2019; 2019:7247325). In order to establish utility of automated FDG-PET classification, an advanced machine learning technique, transfer learning was introduced. The use of machine learning, and in particular transfer learning, for classifying FDG-PET images of people with subtypes of AD is novel. The ResNet-18 convolutional network with transfer learning was chosen as it provides accurate model building in a very short period of time (Rawat and Wang, Neural Comput. 2017; 29(9):2352-2449). Note that any deep neural network architecture suitable for image classification may be used, such as e.g. squeezenet (Iandola et al., arxiv.org/abs/1602.07360), googlenet, inceptionv3 (Szegedy et al., Proc of IEEE conf comp vis pat recog, pp. 1-9, 2015), densenet201 (Huang et al., CVPR vol. 1, no. 2, p/3, 2017), resnet-50 or -101 (He et al., Proc IEEE conf comp vis pat rec, pp. 770-778, 2016), efficientnetb0 (Migxing Tan and Quoc, Arxiv: 1905.1194, 2019), alexnet (Krizhevsky et al., Adv neur info proc sys, 2012), vgg16 (Simonyan and Ziserman, arxiv: 1409.1556, 2014), etc. The ResNet-18 convolution network with transfer learning was able to distinguish the two subtypes and areas contributing most to typical AD were represented in the red colour on occlusion sensitivity maps (reference numerals 30 on FIG. 3A). Although the machine learning model was trained on full images and did not receive as input any information on regions of interest (ROIs), it was able to pick out regions that are informative of differences between AD and mixed AD. An average accuracy in distinguishing the two subtypes was found to be 97.5% after 5-fold cross validation. Accuracy of prediction in the current study is much higher in comparison to some of the previous studies based on deep learning techniques (Korolev et al., arXiv:170106643 [cs]. Published online Jan. 23, 2017; Lu et al., Sci Rep. 2018; 8) even though previous studies have attempted to distinguish people with AD or mild cognitive impairment (MCI) from healthy controls (Table 4). The accuracy of classification demonstrated here for distinguishing AD patients from patients with mixed dementia is similar to the best accuracies obtained for distinguishing AD patients or cognitively impaired patients from healthy control. The identification of subtypes of AD is a much harder problem that the classification of AD vs control or MCI vs control, or even AD vs MCI. It is therefore surprising that the present method was able to reach such a high level of accuracy at this much more difficult classification task.

The overall accuracy of studies in distinguishing AD from controls was higher in comparison to those studies distinguishing MCI from controls. This implies that most of the models are less accurate at distinguishing the subtle differences between images of groups with some form of memory impairment, i.e. AD and MCI than between cognitively healthy. The current classifier based, on ResNet-18 and transfer learning, is able to distinguish typical and mixed pattern subtypes of AD with an accuracy of 97.5%, despite classifying two subgroups of the same disease.

TABLE 4
Summary of recent studies on AD based on deep learning techniques.

| | | | AD: Healthy | | | MCI: Healthy | | |
|---|---|---|---|---|---|---|---|---|
| | | Data | Controls | | | controls | | |
| References | Modality | processing | Acc. | SEN | SPE | Acc. | SEN | SPE |
| Li et al., Med Image | MRI, PET | 3D CNN | 92.87 | | | 76.21 | | |
| Comput Comput | | | | | | | | |
| Assist Interv. | | | | | | | | |
| 2014; 17(Pt 3): | | | | | | | | |
| 305-312 | | | | | | | | |
| Lu et al., Sci Rep. | MRI, PET | DNN + | 84.6 | 80.2 | 91.8 | 82.93 | 79.69 | 83.84 |
| 2018; 8 | | MMDNN | | | | | | |
| Choi et al., Behav | PET | 3D CNN | 96 | 93.5 | 97.8 | 84.2 | 81.0 | 87.0 |
| Brain Res. | | | | | | | | |
| 2018; 344: 103-109 | | | | | | | | |
| Gupta et al., Front | APOE | SVM | 98.42 | 100 | 96.47 | 95.65 | 100 | 88.89 |
| Comput Neurosci. | measurements, | | | | | | | |
| 2019; 13: 72 | CSF, MRI, PET | | | | | | | |
| Feng et al., Int J | MRI | 3D CNN- | 98.90 | 98.90 | 98.80 | 99.10 | 99.80 | 98.40 |
| Neural Syst. | | SVM | | | | | | |
| 2020; 30(6): 2050032 | | | | | | | | |
| Kim et al. EJNMMI | PET | DNN | 75 | 76 | 75 | | | |
| Res. 2021; 11(1): 56. | | | | | | | | |

MRI = Magnetic resonance imaging, PET = Positron emission tomography, CNN = Convoluted neural network, DNN = Deep neural network, MMDNN = Multiscale multimodal deep neural network Acc = Accuracy, SPE = specificity and SEN = Sensitivity, AD = Alzheimer's disease, MCI = Mild cognitive impairment, SVM = Support vector machine, CSF = Cerebrospinal fluid (measurement of e.g. the 42-residue-long Amyloid-β isoform or total tau), APOE = Apolipoprotein E.

This study is first of its kind to introduce deep learning to classify FDG-PET images from people with AD into two clinically important subtypes “Typical AD” and “mixed”. The overlapping mixed pathology in people with AD poses a challenge for clinicians in diagnosis and patient management. Introduction of an automated transfer learning technique to classify patients into typical AD and mixed subtype will not only facilitate an accurate segregation of a pure subset of people with typical AD from mixed but also can offer the potential for more accurate, reproducible and faster diagnosis.

### CONCLUSION

This study is first of its kind in distinguishing two imaging subtypes of AD through visual analysis of FDG-PET images and to then demonstrate that the two subtypes were distinguishable from each other on semi-quantitative analysis and were different clinically. Further, transfer learning, a kind of machine learning, has been used to predict the two subtypes with high accuracy, sensitivity and specificity. In the clinical setting, most images are analysed through visual analysis by experts which is expensive, time-consuming, and has well-known intra- and inter-observer bias. Machine learning techniques like transfer learning may overcome these shortcomings. At a pragmatic level, they may also fill a growing need given the combined challenges of an ageing population and global shortage of radiologists. The novel application of transfer learning which utilized a pre-trained network ResNet-18 in the study, can potentially greatly improve the efficiency and accuracy in distinguishing FDG-PET images of people with typical AD from those with co-existing cerebral small vessel disease. Such application of Al could be beneficial not only in accurate diagnosis and prognosis for individual patients but importantly for identifying the correct patients to recruit to future clinical trials.

The systems and methods of the above embodiments may be implemented in a computer system (in particular in computer hardware or in computer software) in addition to the structural components and user interactions described.

The term “computer system” includes the hardware, software and data storage devices for embodying a system or carrying out a method according to the above described embodiments. For example, a computer system may comprise one or more processing units such as central processing units (CPU) and/or graphics processing units (GPU), input means, output means and data storage. Preferably the computer system has a monitor to provide a visual output display. The data storage may comprise RAM, disk drives or other computer readable media. The computer system may include a plurality of computing devices connected by a network and able to communicate with each other over that network. It is explicitly envisaged that the computer system may consist of or comprise a cloud computer.

The methods of the above embodiments may be provided as computer programs or as computer program products or computer readable media carrying a computer program which is arranged, when run on a computer, to perform the method(s) described above.

The term “computer readable media” includes, without limitation, any non-transitory medium or media which can be read and accessed directly by a computer or computer system. The media can include, but are not limited to, magnetic storage media such as floppy discs, hard disc storage media and magnetic tape; optical storage media such as optical discs or CD-ROMs; electrical storage media such as memory, including RAM, ROM and flash memory; and hybrids and combinations of the above such as magnetic/optical storage media.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example+/−10%.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

1. A method for diagnosing dementia subtypes in one or more patients, the method comprising:
obtaining brain imaging data relating to the one or more patients; and
classifying the one or more patients between a plurality of classes comprising a first class of patients having the first subtype of dementia and a second class of patients having the second subtype of dementia, by providing the brain imaging data relating to the one or more patients as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia.

2. The method of claim 1, wherein the subtypes of dementia are subtypes of Alzheimer's disease (AD), wherein the first subtype of dementia is AD, wherein the second subtype of dementia is AD in combination with cerebrovascular disease or vascular dementia, wherein the second type of dementia is cerebrovascular disease or vascular dementia, wherein the second subtype of dementia is mixed AD and/or wherein the second subtype of dementia is not AD.

3. The method of any preceding claim, wherein the classifying is between the first class of patients having the first subtype of dementia and the second class of patients having the second subtype of dementia.

4. The method of any preceding claim, wherein the deep learning model is a deep neural network classifier and/or wherein the deep learning model comprises a convolutional neural network (CNN), wherein the deep learning model comprises a model that has been pretrained on unrelated image data, and/or wherein the deep learning model comprises a CNN that has been pre-trained using a deep residual learning framework.

5. The method of any preceding claims, wherein the deep learning model comprises all layers of a CNN that has been pretrained for image recognition apart from the classification layer, and a classification layer trained using the first and second set of images and associated labels, optionally wherein the classification layer comprises a fully connected layer and a softmax layer.

6. The method of any preceding claim, wherein the images in the first set and the second set show evidence of different metabolic activity in any one or more of, or all of: the right frontal cortex, left frontal cortex, right temporal cortex, left temporal cortex, right parietal cortex, left parietal cortex, left cerebellum and right cerebellum.

7. The method of any preceding claim, wherein the images in the second set of images show evidence of hypo-metabolism in regions of the brain comprising one or more of, or all of: the right frontal cortex, left frontal cortex, left cerebellum and right cerebellum, instead or in addition to one or more of: the right temporal cortex, left temporal cortex, right parietal cortex, and left parietal cortex.

8. The method of any preceding claim, wherein hypo-metabolism refers to a lower glucose uptake rate and/or blood flow and/or FDG-PET derived Standardized Uptake Value Ratio (SUVR) than expected for a control.

9. The method of any preceding claim, wherein the brain imaging data is imaging data acquired using any functional brain imaging modality providing information about the metabolic activity of a brain region imaged, optionally wherein the information about the metabolic activity of a brain region imaged is obtained by detecting glucose uptake by a brain region imaged and/or blood flow to the brain region imaged.

10. The method of any preceding claim, wherein the brain imaging data is FDG-PET data or ASL data, and/or wherein the brain imaging data is baseline functional brain imaging data.

11. The method of any preceding claim, wherein analysing the data using a deep learning model comprises analysing a single section of the brain imaging data for each patient and/or wherein the method comprises selecting a single section of a set of brain imaging data for each patient, optionally wherein the single section is a single axial section at the level of the thalamus and/or wherein the single section is a section including at least part of the hippocampus and entorhinal cortex.

12. The method of any preceding claim, wherein the brain imaging data used to train the deep learning model comprises a single section of a set of brain imaging data for each of the plurality of patients and/or wherein the method comprises selecting a single section of a set of brain imaging data for each of the plurality of patients, optionally wherein the single section is a single axial section at the level of the thalamus and/or wherein the single section is a section including at least part of the hippocampus and entorhinal cortex.

13. The method of any preceding claim, wherein the first set of images comprises one or more images for each of at least 30, at least 40, at least 50, at most 500, at most 200 or at most 100 patients, and/or the second set of images comprises one or more images for each of at least 30, at least 40, at least 50, at most 500, at most 200 or at most 100 patients, and/or the first set of images comprises one or more images for each of a number of patients that is within 10% or within 20% or the number of patients for which one or more images are included in the second set of images, and/or wherein the first and second sets of images comprise one or more images for each of a plurality of patients wherein the plurality of patients for the first and second sets of images are age- and sex-matched.

14. The method of any preceding claim, wherein the first set of images has been labelled as associated with a first subtype of dementia and the second set of images has been labelled as associated with a second subtype of dementia by expert reviewing of the first and second set of images, optionally wherein each image of the first set of images and the second set of images has been assigned the same label by at least two experts.

15. The method of any preceding claim, wherein the brain imaging data used to train the deep learning model comprises images from a plurality of patients and images obtained from images from the images form the plurality of patients by image augmentation, optionally wherein the image augmentation comprises creating a flipped version of one or more of the images and/or creating a randomly rotated version of one or more of the images.

16. The method of any preceding claim, wherein the deep learning model classifies images in the first and second classes with an accuracy of at least 90%, or at least 95%, and/or wherein the deep learning model classifies images in the first and second classes with a sensitivity of at least 90%, or at least 94%, and/or wherein the deep learning model classifies images in the first and second classes with a specificity of at least 90%, or at least 95%.

17. The method of any preceding claim, wherein the method further comprises training the deep learning model using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia.

18. A method of providing a tool for diagnosing dementia subtypes in one or more patients, the method comprising:
obtaining training image data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and
training a deep learning model to classify a patient between a plurality of classes comprising a first class of patients having the first subtype of dementia and a second class of patients having the second subtype of dementia, using the training image data.

19. A method of selecting a subject that has been diagnosed as having AD or being likely to have AD for participation in a clinical trial, the method comprising:
classifying the subject between a plurality of classes comprising a first class of patients having the first subtype of dementia and a second class of patients having the second subtype of dementia, by providing brain imaging data relating to the subject as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and
selecting or excluding the subject from participation in the clinical trial depending on whether the subject was classified as having a first dementia subtype or a second dementia subtype.

20. A method of providing a prognosis for a subject that has been diagnosed as having AD of being likely to have AD, the method comprising:
classifying the subject between a plurality of classes comprising a first class of patients having the first subtype of dementia and a second class of patients having the second subtype of dementia, by providing brain imaging data relating to the subject as input to a deep learning model that has been trained using brain imaging data from a plurality of patients, the brain imaging data comprising a first set of images showing evidence of temporo-parietal hypo-metabolism, and a second set of images showing evidence of hypo-metabolism in regions of the brain other than the temporal and parietal regions instead or in addition to the temporal and parietal regions, wherein the first set of images is labelled as associated with a first subtype of dementia and the second set of images is labelled as associated with a second subtype of dementia; and
determining a prognosis for the subject based on whether the subject was classified as having a first dementia subtype or a second dementia subtype, optionally wherein determining a prognosis comprises determining that the subject is likely to have a faster rate of cognitive decline if the subject is classified in the second class than if the subject is classified in the first class.

21. A system for diagnosing dementia subtypes and/or providing a tool for diagnosing dementia subtypes, the system comprising: one or more processors and computer readable memory storing instructions that cause the processor to perform the method of any of claims 1 to 18, optionally wherein the system further comprises data acquisition means configured to obtain brain imaging data relating to one or more patients.

22. A non-transitory computer readable storage medium containing machine executable instructions which, when executed on a processor, cause the processor to perform the method of any of claims 1 to 18.

23. A computer program comprising executable code which, when run on a computer, causes the computer to perform the method of any of claims 1 to 18.
